(19) United States
(12) Patent Application Publication
(10) Pub. No.: US 2006/0191791 A1
(43) Pub. Date: Aug. 31, 2006

(54) Electric device for determining aeriform substances

(76) Inventor: Dario Narducci, Milan (IT)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/359,362

(22) Filed: Feb. 23, 2006

(30) Foreign Application Priority Data
Feb. 25, 2005 (IT) RM2005A000081
Feb. 25, 2005 (IT) RM2005A000082
Feb. 25, 2005 (IT) RM2005A000083

(51) Int. Cl. G01N 27/26

(52) U.S. Cl. 204/431

(57) ABSTRACT

An electric device for determining aeriform substances, made from a multi-layer structure with a layer of semiconductor material, a layer of organic material and a layer of metallic material, wherein the layer of semiconductor material has a crystalline structure, the layer of organic material has a coverage degree not greater than 1 and is made of a substance the molecules of which are self-sustaining in an ordered manner, are bound to atoms of the crystalline structure of the semiconductor and interact with said aeriform substance to be determined in the sense of modulating the barrier height of the junction within the multi-layer, and the layer of metallic material is permeable to the aeriform substance to be determined and is chemically inert towards it.

### BACKGROUND OF THE INVENTION

The present invention relates to an electric device for determining aeriform substances.

Chemical sensors for aeriforms are known based on modifying the electrical response consequent on the interaction between aeriform molecules and the surface of a dielectric.

These known devices mainly use transition metal oxides such as copper oxide, zinc oxide or tin dioxide. The electronic density of the oxide is altered by the surface adsorption of aeriforms, to produce measurable electrical resistivity variations, which are rapidly produced under relatively low operating temperature conditions.

However the sensitivity of these known resistivity sensors, in terms of their capacity to discriminate among gas mixtures both in a qualitative and in a quantitative way, is known to be fairly low and difficult to predict beforehand.

Consequently these known resistivity sensors have been validly used in monitoring gaseous mixtures of simple and partially known composition, for example in the analysis of industrial effluent, whereas they have proved much less valid as monitoring systems in complex atmospheres and/or in the analysis of organic gases.

Resistivity sensors based on the use of organic and/or metallorganic materials are also known.

For example phthalocyanine, porphyrine and other organic metals have been used to construct sensitive layers, consisting either of single molecules or of polymer layers, deposited as thin films on suitable substrates. It is also known how to form ordered organic substrates by molecular self-organization using a wide variety of self-assembly processes which range from Langmuir films to thiols self-assembled on gold or other metals.

These latter devices offer better selectivity characteristics but present new problems connected with stability and with reproducibility of the response of the devices themselves and with their preparation.

The invention proposes to solve the problems of known devices relative to selectivity, stability and reproducibility in sensor operation in order to provide a sensor which is simple to prepare and adaptable to various applications.

### SUMMARY OF THE INVENTION

These and other objects which will be apparent from the ensuing description are attained according to the invention by an electric device for determining aeriform substances, comprising a multi-layer structure with a layer of semiconductor material, a layer of organic material and a layer of metallic material, characterised in that:
the layer of semiconductor material has a crystalline structure,
the layer of organic material has a degree of covering not greater than 1 and consists of a substance the molecules of which are self-sustaining in an ordered manner, are bound to atoms of the crystalline structure of the semiconductor and interact with said aeriform substance to be determined, in the sense of modulating the barrier height of the junction within the multi-layer, and
the layer of metallic material is permeable to said aeriform substance to be determined and is chemically inert towards it.

### BRIEF DESCRIPTION OF THE DRAWINGS

A preferred embodiment of the present invention and some examples of its preparation are described in detail hereinafter by way of non-limiting example with reference to the accompanying drawings, in which:

FIG. 1 is a vertical section through a multi-layer structure forming a device of the invention;

FIG. 2 shows the resistive response of a silicon surface modified with 2,4-diamino-phenylene to the introduction (•→) and to the removal (x→) of 24 ppmV of 2,4-dinitrotoluene;

FIG. 3 shows the scheme of a bisensor comprising at least one device of the invention and a logic comparator; and

FIG. 4 shows the response (a) of a silicon surface modified with 1,2-(methylenedioxy)benzene, the response (b) of a commercial sensor for methane, and the response (c) of a bisensor logic comparator to the introduction (•→) and to the removal (x→) of 1 vol % of ethyl alcohol and to the introduction (•→) and to the removal (x→) of 0.1 vol % of odorized methane gas.

### DETAILED DESCRIPTION OF THE INVENTION

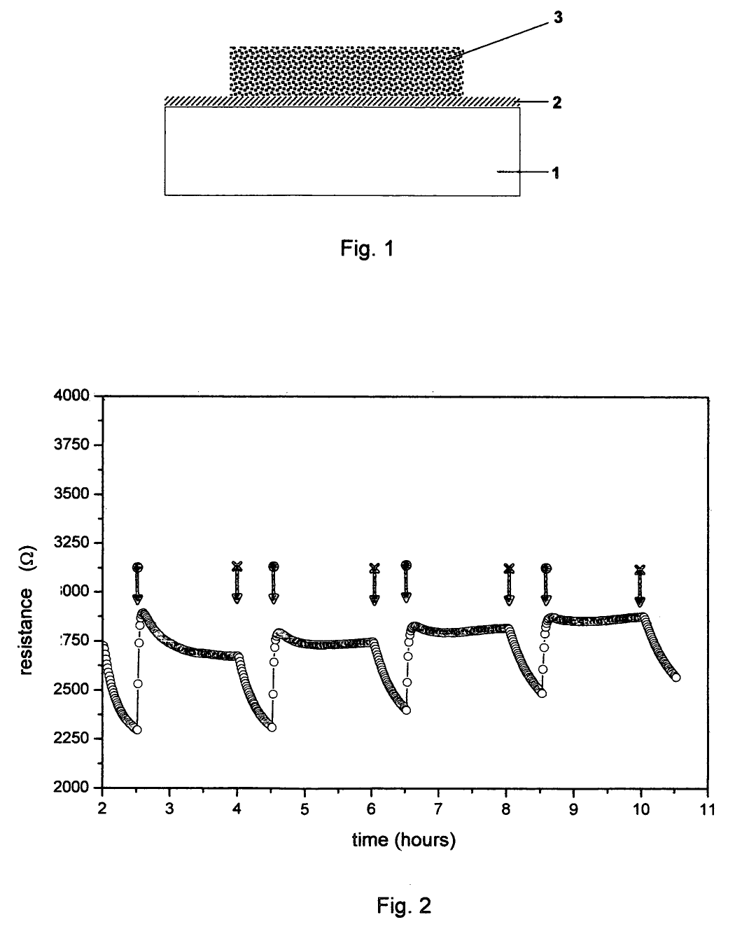

With reference to FIG. 1, the invention can be defined as an electric device of multi-layer structure for the selective determination of aeriform substances. The multi-layer structure comprises a support layer consisting of a semiconductor material 1 of crystalline structure such as monocrystalline silicon or alloys of semiconductors or composite semiconductors. Usable of these latter are SiC or Si₃N₄ or SiₓGe₁₋ₓ alloys or binary or multinary compounds or elements of groups III and V of the Periodic Table, such as GaAs, InSb, InP, AlₓGa₁₋ₓAs.

On this support layer, a layer of organic material 2 consisting of molecules of a self-sustaining substance is formed in an ordered manner on the surface of the semiconductor layer and bound by one or more direct bonds to the surface atoms of the crystalline structure of said semiconductor. Said layer of organic material 2 is advantageously a submonolayer, i.e. such as to produce only a partial coverage of the semiconductor support surface. For example, suitable for producing layers of this type are organic molecules with no conformational degrees of freedom such as molecules consisting of or comprising aromatic, heteroaromatic or polyaromatic rings or unsaturated hydrocarbon chains, possibly conjugated.

Said molecules interact with the aeriform to be determined in the sense that the presence of the aeriform modifies the barrier height of the metal-organic submonolayer-semiconductor junction of the sensing device, as will be more evident in the explanation of the principle of operation of the device.

Said self-sustaining organic layers can also be used to generate dielectric polarization effects in field effect devices such as MIS diodes, MISFET, MOSFET, JFET structures or geometries similar to those used in known ChemFET and GASFET devices.

On the surface of said monolayer of organic material 2 a layer of metallic material 3 permeable to said aeriform to be determined and inert towards it is deposited, for example a porous layer of gold or other metal alloys or compounds with metallic characteristics.

A device according to the invention presents a structure geometrically similar to that of a known insulating metal and semiconductor junction structure (MIS). The physics governing the operation of the device of the invention is however completely different. In this respect, the organic molecular submonolayer 2 interposed between the metal electrode 3 and the semiconductor 1 dynamically alters the barrier height of the junction on the basis of the adsorption of the aeriform to be determined. If μ is the electric dipole moment of the component organic molecular fragment of the submonolayer and μ_{z} its component normal to the semiconductor surface, the barrier height φ is modified by the presence of the self-sustaining organic layer by a quantity φₒ proportional to Nμ_{z}, where N is the number of molecular fragments bound per unit of surface. In the presence of gas, if the sensitive layer is able to establish intermolecular interactions with the aeriform molecule which are characterised by energies at least of the order of k_{B}T (where k_{B} is the Boltzmann constant and T is the absolute temperature at which the device operates) and if the conformations of the complex formed by the aeriform molecule and the organic fragment bound to the surface are separated by interconversion barriers also at least of the order of k_{B}T, the barrier height φ is uniformly altered by a quantity φ_{g} equal to χN(μg)_{z}, where (μ_{g})_{z} is the component normal to the semiconductor surface of the dipole moment of the aeriform molecule locked on the molecular fragment and χ is the fraction of fragments which lock the gaseous molecules. It is also simple to demonstrate that χ is a function of the partial pressure of the gas in the measurement environment.

The above explanation of the principle of operation demonstrates the crucial importance, in the operation of the device, of an ordered arrangement of molecular moieties on the semiconductor surface. A structurally disordered sensitive layer would lead to a reduction in the mean value of (μ_{g})_{z}, thereby drastically reducing or cancelling the device sensitivity.

A device according to the invention operates in accordance with completely different principles than those used by known biosensors, as described for example in German Patent 10,201,653 and in N. K. Chaki and K. Vijayamohanan, “self-assembled monolayers as a tunable platform for biosensor applications”, Biosensors and Bioelectronics, 17(1-2)(2002) 1-12, and is produced by processes of semiconductor surface modification which differ significantly from the procedures described in W09937409 and in U.S. Pat. No. 6,677,163B1.

In particular, the organic molecule self-assembly processes normally used on metal or dielectric substrates require the generation of strong intermolecular interactions between the organic molecules. In the case of molecules characterised by hydrocarbon chains, these interactions can take place with sufficient intensity only if the organic molecules reach a virtually unitary surface coverage degree and, at the same time, if functional groups connected to the hydrocarbon chain which can hinder packing of the monolayer are absent. This implies for example the impossibility of producing ordered monolayers using molecules functionalized in positions other than the beginning and/or the end of the hydrocarbon chain. Moreover, the strong packing of the monolayer necessary to ensure its ordered arrangement strongly limits the diffusion of the gaseous molecules through the monolayer, so inhibiting or significantly slowing the response of the device to variation in the concentration or nature of the aeriform to be determined.

Moreover, if the organization of the organic layer is promoted using terminal groups able to achieve chemical bonds with the substrate, the time stability of the hence modified surface, and thus of the device, can appreciably degrade in the presence of chemical agents able to cause detachment of the assembled molecules. Stability problems are known, for example, in the presence of chemical bonds with the substrate which are generated by silanol groups able to produce several Si—O—Si bonds with oxidized silicon or silicon oxide surfaces. These bridging bonds are hydrolysed in the presence of chemical agents such as water, acids, alcohol etc. The hydrolysis results in partial detachment of the assembled molecules and hence time instability of the device.

A further problem encountered in the production of monolayers used to form the devices of the invention is the need to deposit metal layers constituting an electrode to cover the organic layer. This need conflicts with the double requirement of allowing the gaseous molecules to diffuse and hence interact with the sensitive organic layer and also conflicts with the low thermal stability of the organic molecules themselves which, in the evaporation or cathodic sputtering processes required for depositing said electrode, can suffer severe thermal degradation, up to full carbonization of the organic layer.

To produce the device of the invention, the said problems of using known organic molecule self-assembly processes, i.e. surface modification of semiconductor surfaces and metal layer deposition, are solved by using the particular classes of organic molecules according to the invention for constructing the organic layer 2 and controlling the conditions under which the final metal layer 3 is deposited by cathodic sputtering.

The organic molecules used for constructing the sensitive organic layer 2 in devices of the invention are chosen so as to ensure that an ordered organic layer is obtained even in the absence of strong intermolecular interactions between the organic molecules themselves. Molecules with such capabilities are defined herein as “self-sustaining” in that, consisting for example of aromatic, heteroaromatic and polyaromatic rings and unsaturated hydrocarbon chains, possibly conjugated, and having no conformational degrees of freedom, these molecules, when bound to the ordered surface of the crystalline substrate, self-assemble to assume the only possible conformation, and in this manner they replicate in the organic layer the ordered arrangement characteristic of the substrate itself. The arrangement is therefore not induced by the dense packing of the molecules of the organic layer but by said characteristic capacity for self-sustainment of the molecular structure of its constituent organic molecules. Consequently, the resultant organic layer can be less compact, even with a coverage degree significantly less than 1. This allows a more effective diffusion of the gaseous molecules to be determined through the organic layer and consequently significantly reduces the response times of the device.

The nature of the chemical bonds between the constituent molecules of the organic layer 2 and the semiconductor substrate 1 determines the thermal and chemical stability of the organic layer and hence of the device. The molecule families chosen for forming the device of the invention are able to generate with the substrate very stable Si—C bonds presenting a low polarity and are hence stable even in the presence of hydrolysing agents.

Finally the electrode 3 deposited on the self-sustaining organic layer is produced using metal film deposition by cathodic sputtering of metals which are not chemically reactive, for example gold. Sputtering is carried out with low deposition rates so as not to damage the underlying organic layer while at the same time generating porous metal films enabling the monitored aeriforms to diffuse towards the self-sustaining organic layer 2.

A particular application is the production of a sensor according to the invention for use in sensing explosives for civil and/or military use based on or containing aromatic or heteroaromatic nitroderivatives such as TNT (2,4,6-trinitrotoluene), tetryl (trinitro-2,4,6-phenylmethylnitroamine), tacot (tetranitrodibenzo-1,3a,4,6a-tetraazapentalene) or 2,4,6-triazido[1,3,5]triazine. For this application the self-sustaining organic layer is obtained by modifying semiconductor surfaces starting from at least one aromatic substance of general formula: 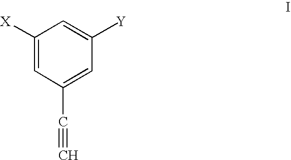
where X and Y are independently iodine or a —NR₁R₂ group; in which R₁ and R₂ can be equal or different and are independently chosen from the group comprising hydrogen and C₁-C₅ alkyl radicals.

For example this class of molecules comprises 3,5-diiodophenylethyne, 3,5-(N,N-dimethylamino)phenylethyne, 3,5-diaminophenylethyne, 3-iodo-5-aminophenylethyne.

For this application the aeriform organic layer is alternatively obtained by modifying semiconductor surfaces starting from at least one 2,4 substituted phenylethyne of general formula: 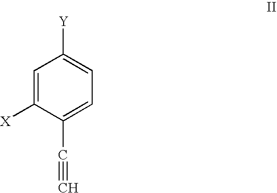
where X and Y are independently iodine or a —NR₁R₂ group; in which R₁ and R₂ can be equal or different and are independently chosen from the group comprising hydrogen and C₁-C₅ alkyl radicals.

The molecules of families I and II are characterised by the presence of electron-attractor functional groups mutually positioned in meta positions and for family I in meta also with respect to the acetylenic residue. The presence of these groups enables acceptor-donor interactions to be generated between the aromatic ring of the nitroderivative to be determined and the aromatic ring of the aryl fragment bound to the semiconductor, to generate a supermolecular complex able to modify the barrier height of the metal/organic layer/semiconductor junction of the sensing device. The acetylene residue enables the aryl ring not to be directly bound to the silicon surface but to be suitably spaced from it by a trans-ethenyl fragment 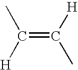
which absolves the double role of reducing steric interactions between the arene and the surface and of preserving structural rigidity of the aryl-ethenyl fragment on the semiconductor surface.

The aromatic nature of the bound fragments obstructs the diffusion of polar molecules towards the semiconductor surface. This hence hinders deactivation of the device by water vapour in humid environments.

The aromatic ring can also be further substituted in the ortho or meta or para positions with respect to the acetylene group in the precursor molecule. Suitable substituents can be the methyl or carboxyl or methoxy group such as in the molecules of 3-iodo-4-methyl-5-(N-methyl-N-ethylamino) phenylethyne or of 1-methoxy-3-iodo-5-(N-methyl-N-ethylamino) phenylethyne.

It is also apparent that the arylethenyl fragments bound to the silicon and constituting the self-sustaining organic layer can be further functionalized in situ.

Effective semiconductor surface modification to obtain sensors which can be used to sense said explosives can also be expected by using other aromatic or polyaromatic molecules with substituents independently chosen from iodine and —NR₁R₂; with R₁ and R₂ each chosen from the group comprising hydrogen and alkyl radicals, with said substituents positioned mutually in meta and in meta with respect to a generic unsaturated aliphatic residue able to ensure self-sustainment of the molecule on the semiconductor surface.

A further particular application of the device of the invention is in the field of safety sensors for detecting fuel gas in civil and domestic environments. For this case the device organic layer is formed starting from organic molecules which are suitable for detecting odorizing gases (a thioderivative) present by law in fuel gases such as methane gas, natural gas or ‘city gas’. Said precursor molecules are advantageously chosen from the molecules pertaining to the general structural class: 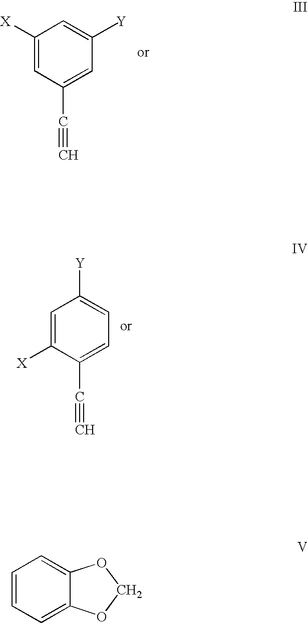
where X and Y are independently iodine or an SR group, in which R can be chosen from the group comprising hydrogen and C₁-C₃ alkyl radicals,
the semiconductor material consists of monocrystalline silicon or alloys of semiconductors or compound semiconductors,
the metallic material layer consists of a porous layer of gold or metal alloys or compounds with metallic characteristics.

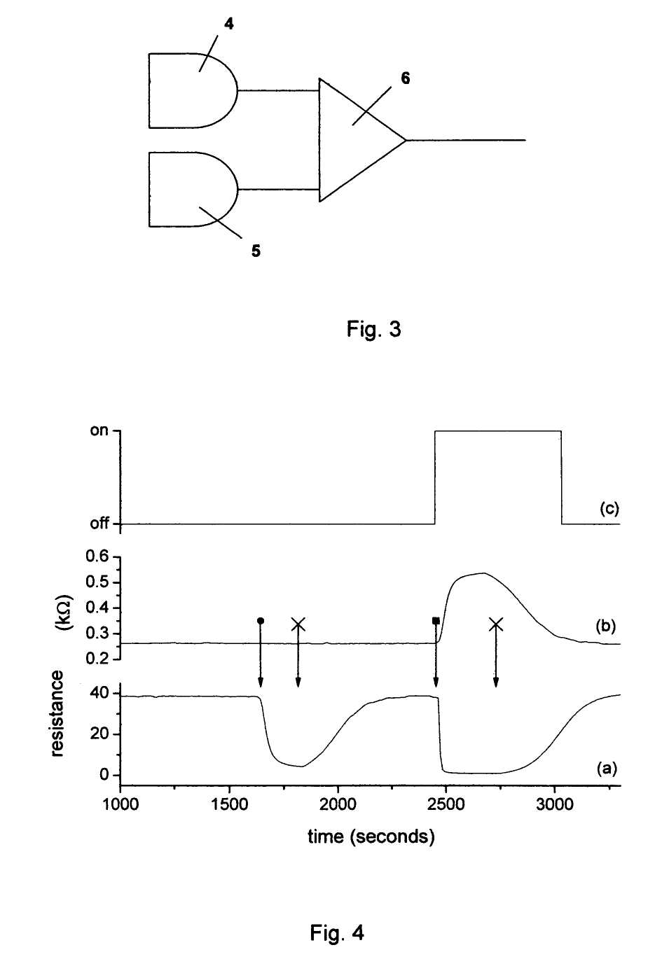

In this application the sensor 4 (see FIG. 3) is advantageously used coupled to a second sensor 5 for aspecific detection of said reducing gases. The second sensor 5 can be a resistive sensor or a semiconductor or an electrochemical sensor or a surface acoustic wave sensor. The two sensors 4 and 5 provide signals handled via a logic comparator 6. The described bisensor results in cost economy over complex control systems based on logic neuron networks normally used in industry to control sensor matrices, this enabling the bisensor to be used in the civil and domestic user market. The production of effective bisensor systems not requiring the use of neuron networks or other artificial intelligence algorithms depends critically on the particular selectivity and sensitivity of the odorizer detecting sensor according to the invention. The response of said sensor combined with the response of a conventional sensor enables, by merely comparing the response of the two sensors, a state of alarm to be activated if and only if both the sensors are in an alarm state, an event associated only with the simultaneous presence of an organic thioderivative and a combustible gas in the air. This hence produces a significant reduction in false negative situations (i.e. absence of necessary alarm states due to the poor sensitivity of conventional sensors for odorizers, which are generally present in a concentration of the order of one part per trillion) and of false positive situations (false alarms due to the impossibility of selectively sensing odorizers by known gas sensors).

The principle of the described bisensor can be applied to determinations on aeriforms accompanying at least one other characteristic aeriform in the composition of the gaseous emission to be monitored. In this sense some potential application fields are the determination of aromas in foods, or of explosives by, in such a case, combining the particular sensor of the aforedescribed application for explosives with sensors for the industrial trace compounds (taggers) added to the explosives formulations.

Other applications are foreseeable for example in the gas-chromatographic field of separation and determination of compounds in complex gaseous emissions or mixtures.

### EXAMPLES

The following examples are included for a better understanding of the invention and particularly of some of its applications.

### Example 1

The surface of a monocrystalline substrate is modified by partially covering with 2,4-diamino-phenylethyne which is chemically bound to the substrate surface by a hydrosilylation reaction catalysed by organometallic complexes of transition metals with formation of covalent Si—C bonds which stably bind the arylethenyl fragments to the substrate surface in accordance with the following procedure:

Starting with a (100) surface of type p Si (resistivity of 8-10 ohm×cm), the wafer is washed in trichloroethylene for 10 minutes at a temperature of about 80° C. in a pyrex glass beaker followed by washing in acetone for 10 minutes at a temperature of about 50° C. in a pyrex glass beaker, and rinsed in bidistilled water at room temperature under stirring in a pyrex glass beaker. The sample then undergoes (1) etch in an APM mixture (NH₃ (32 vol %):H₂O₂ (30 vol %):bidistilled H₂O in a volumetric ratio 1:1:5) for 10 minutes at a temperature of about 80° C. in a pyrex glass beaker followed by washing for 2 minutes under stirring in cold bidistilled water in a pyrex glass beaker; (2) etch in dilute HF (HF (50 vol %): H₂O in volumetric ratio 1:50) for 30 seconds under stirring at room temperature in a Teflon beaker followed by washing for 2 minutes under stirring at room temperature in bidistilled water in a pyrex glass beaker; (3) etch in a HPM mixture (HCl (37%):H₂O₂ (30%):H₂O in volumetric ratio 1:1:5) for 10 minutes at a temperature of about 80° C. in a pyrex glass beaker followed by washing at room temperature for 2 minutes under stirring in bidistilled water in a pyrex glass beaker; (4) treatment in dilute HF (HF (50 vol %): H₂O in volumetric ratio 1:50) at room temperature for 30 seconds under stirring followed by rinsing with bidistilled water in a teflon beaker and drying in air or under a nitrogen flow.

The surface prepared in this manner is subjected to the self-assembly reaction.

The samples are placed in a previously dried reactor overnight in an oven at 110° C. After conditioning the reactor under nitrogen, further heating is applied with a heat gun. Simultaneously 50 ml of anhydrous methylene chloride are deoxygenated in a scrubber for about 30 minutes. 100 mg of Ru(CO)HCl(PPh₃)₃ catalyst together with 210 mg of 2,4-diamino phenylethyne precursor are added to the reactor as quickly as possible to prevent air entry. After closing the reactor, 21 ml (required to cover the samples) of methylene chloride are added and the contents allowed to react for about 22 hours under stirring. After this period the solution is extracted with a syringe and the samples are dried with anhydrous degassed CH₂Cl₂ while maintaining the reactor under nitrogen and stirring. At this point the samples can be extracted and subjected to sonication in methylene chloride, water and again in methylene chloride for 5 minutes at room temperature.

Finally the submonolayer is covered by depositing a porous metal layer of gold acting as the electrode permeable to the gas to be determined. The electrode is formed by cathodic sputtering of gold, depositing the metal under a deposition voltage of 1 kV at a pressure of 4×10⁻² torr of Ar for 8 minutes, to hence obtain a film about 80 nm thick.

The sensor of the example is specific for determining aromatic nitroderivatives, FIG. 4 showing the resistive response of the sensor to 2,4-dinitrotoluene.

### Example 2

The surface of a monocrystalline substrate is modified by partial covering it with benzyl 1-ethynyl-3,5-(N,N-dimethylamino)-benzoate which is chemically bound to the substrate surface by a hydrosilylation reaction catalysed by organometal complexes of transition metals with formation of covalent Si—C bonds which stably bind the arylethenyl fragments to the substrate surface in accordance with the following procedure:

Starting with a (100) surface of type p Si (resistivity of 8-10 ohm×cm), the wafer is washed in trichloroethylene for 10 minutes at a temperature of about 80° C. in a pyrex glass beaker followed by washing in acetone for 10 minutes at a temperature of about 50° C. in a pyrex glass beaker, rinsed in bidistilled water in a pyrex glass beaker at room temperature. The sample then undergoes (1) etch in an APM mixture (NH₃(32 vol %):H₂O₂ (30 vol %):bidistilled H₂O in a volumetric ratio 1:1:5) for 10 minutes at a temperature of about 80° C. in a pyrex glass beaker followed by washing for 2 minutes under stirring in cold bidistilled water in a pyrex glass beaker; (2) etch in diluted HF (HF (50 vol %): H₂O in volumetric ratio 1:50) for 30 seconds under stirring in a Teflon beaker at room temperature followed by washing for 2 minutes under stirring at room temperature in bidistilled water in a pyrex glass beaker; (3) etch in a HPM mixture (HCl (37%):H₂O₂ (30%):H₂O in volumetric ratio 1:1:5) for 10 minutes at a temperature of about 80° C. in a pyrex glass beaker followed by washing for 2 minutes under stirring at room temperature in bidistilled water in a pyrex glass beaker; (4) treatment in diluted HF (HF (50 vol %): H₂O in volumetric ratio 1:50) for 30 seconds at room temperature under stirring followed by rinsing with bidistilled water in a teflon beaker and drying in air or under a nitrogen flow.

The surface prepared in this manner is subjected to the self-assembly reaction.

The samples are placed in the reactor, previously dried overnight in an oven at 110° C. After conditioning the reactor under nitrogen, further heating is applied with a heat gun. Simultaneously 50 ml of anhydrous methylene chloride are deoxygenated in a scrubber for about 30 minutes. 94 mg of Ru(CO)HCl(PPh₃)₃ catalyst together with 300 mg of benzyl 1-ethynyl-3,5-(N,N-dimethylamino)-benzoate precursor are added to the reactor as quickly as possible to prevent air entry. After closing the reactor, 20 ml (required to cover the samples) of methylene chloride are added and the contents allowed to react for about 22 hours under stirring. After this period the solution is extracted with a syringe and the samples are dried with anhydrous degassed CH₂Cl₂ while maintaining the reactor under nitrogen and stirring. At this point the samples can be extracted and subjected to sonication in methylene chloride, water and again in methylene chloride (for 5 minutes at room temperature). The samples obtained in this manner are then placed in a dried reactor kept under a nitrogen flow, covered with a 1:1 solution of trifluoroacetic acid/CH₂CH₂ and allowed to react for 24 hours. The reaction solution is then eliminated and the samples washed with methylene chloride. The samples are finally sonicated for 10 minutes in CH₂CH₂ and 10 minutes in water.

Finally the layer is covered by depositing a porous metal layer of gold acting as the electrode permeable to the gas to be determined. The electrode is formed by cathodic sputtering of gold, depositing the metal under a deposition voltage of 1 kV at a pressure of 4×10⁻² torr of Ar for 8 minutes, to hence obtain a film about 80 nm thick.

### Example 3

The surface of a monocrystalline substrate is modified by partially covering it with 1,2-(methylenedioxy)benzene which is chemically bound to the substrate surface by a nucleophilic substitution using organometallic compounds with formation of covalent Si—C bonds which stably bind the aryl fragments to the substrate surface in accordance with the following procedure:

Starting with a (100) surface of type p Si (resistivity of 8-10 ohm×cm) it is washed in trichloroethylene for 10 minutes at a temperature of about 80° C. in a pyrex glass beaker followed by washing in acetone for 10 minutes at a temperature of about 50° C. in a pyrex glass beaker, and rinsed in bidistilled water at room temperature under stirring in a pyrex glass beaker. The sample then undergoes (1) etch in an APM mixture (NH₃(32 vol %):H₂O₂ (30 vol %):bidistilled H₂O in a volumetric ratio 1:1:5) for 10 minutes at a temperature of about 80° C. in a pyrex glass beaker followed by washing for 2 minutes under stirring in bidistilled water at room temperature in a pyrex glass beaker; (2) etch in cold diluted HF (HF (50 vol %): H₂O in volumetric ratio 1:50) for 30 seconds under stirring in a Teflon beaker followed by washing for 2 minutes under stirring in bidistilled water at room temperature in a pyrex glass beaker; (3) etch in a HPM mixture (HCl (37%):H₂O₂ (30%):H₂O in volumetric ratio 1:1:5) for 10 minutes at a temperature of about 80° C. in a pyrex glass beaker followed by washing for 2 minutes under stirring in bidistilled water at room temperature in a pyrex glass beaker; (4) treatment in diluted HF (HF (50 vol %): H₂O in volumetric ratio 1:50) at room temperature for 30 seconds under stirring followed by rinsing with bidistilled water in a teflon beaker and drying in air or under a nitrogen flow.

The surface prepared in this manner is subjected to the self-assembly reaction.

To prepare the organometallic reagent, a two-neck flask is dried overnight in an oven at 110° C. and further heated with a heat gun while conditioning in nitrogen. 73 mg of magnesium (in chips or grains) are placed therein and the main neck is plugged with a rubber plug; heating is again applied for 15 minutes with a heat gun. An iodine crystal and 4 ml of anhydrous THF are added with a syringe and the contents refluxed under magnetic stirring. A quantity of 4-bromo-1,2-(methylenedioxy)benzene equimolar with respect to the Mg is then added slowly. The reaction is allowed to proceed under nitrogen for about two hours or until the magnesium has been completely consumed. The solution gets the amber colour typical of Grignard reagents.

Methylene chloride (either anhydrous or dried with Na₂SO₄ for one hour in a flask plugged with a turnable rubber baffle) is degassed with N₂ in a scrubber for one hour. 20 ml of this CH₂Cl₂ are fed by syringe into the reactor (previously dried overnight at 110° C.) together with the sample. 50 μl of Br₂ (99%) are added with a syringe and the reactor content is irradiated by a 300 Watt tungsten filament lamp under stirring for 10 minutes. After extracting the brominating mixture with a syringe, the samples still in the reactor under nitrogen are washed with anhydrous deoxygenated CH₂Cl₂. With the reactor thoroughly dry (after complete evaporation of the methylene chloride used for the washing), the previously prepared Grignard reagent is used to self-assembly.

The previously prepared quantity of Grignard reagent, still in the two-neck flask under nitrogen, is extracted with a syringe and placed in the reactor containing the samples activated by photobromination. Anhydrous THF (added by syringe) is added so as to ensure complete coverage of the samples by the solution and the sample is allowed to react under nitrogen for about 20 hours at 40° C. under stirring. After this period, the solution is extracted by syringe and the samples rinsed with THF while keeping the reactor under nitrogen and magnetic stirring. Only at this point are the samples extracted and sonicated in methylene chloride, water and again in methylene chloride (for 5 minutes at room temperature).

The electrode is formed by cathodic sputtering of gold, depositing the metal under a deposition voltage of 1 kV at a pressure of 4×10⁻² torr of Ar for 8 minutes, to hence obtain a film about 80 nm thick.

The sensor of the example is advantageously used coupled to non-selective generic sensors for reducing gases (methane, natural gas or towns gas) such as conventional resistive sensors (for example MIS) or other electrochemical or acoustic wave sensors. The two sensors provide signals of state as shown in FIG. 4, which are processed by a logic comparator.

What is claimed is:

1. An electric device for determining aeriform substances, comprising a multi-layer structure with a layer of semiconductor material, a layer of organic material and a layer of metallic material, wherein:
the layer of semiconductor material has a crystalline structure,
the layer of organic material has a coverage degree not greater than 1 and consists of a substance the molecules of which are self-sustaining in an ordered manner, are bound to atoms of the crystalline structure of the semiconductor and interact with said aeriform substance to be determined in the sense of modulating the barrier height of the junction within the multi-layer, and
the layer of metallic material is permeable to the aeriform substance to be determined and is chemically inert towards it.

2. An electric device as claimed in claim 2 for determining aromatic nitroderivatives, wherein the organic material layer of said multi-layer structure is obtained starting from at least one substituted phenylethyne.

3. An electric device as claimed in claim 2, wherein the organic material layer is obtained starting from at least one 3,5-substituted phenylethyne of general formula: 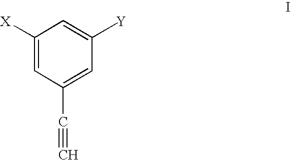
where X and Y are independently iodine or a —NR₁R₂ group; in which R₁ and R₂ can be equal or different and are independently chosen from the group comprising hydrogen and C₁-C₅ alkyl radicals; and where the aromatic ring can also be further substituted in the ortho or para position with respect to the acetylene group.

4. An electric device as claimed in claim 2, wherein the layer of semiconductor material consists of monocrystalline silicon.

5. An electric device as claimed in claim 3, wherein the layer of metallic material consists of porous gold.

6. An electric device as claimed in claim 2, wherein the layer of organic material layer is obtained starting from at least one 2,4-substituted phenylethyne of general formula: 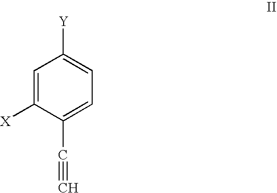
where X and Y are independently iodine or a —NR₁R₂ group; in which R₁ and R₂ can be equal or different and are independently chosen from the group comprising hydrogen and C₁-C₅ alkyl radicals; and where the aromatic ring can also be further substituted in the ortho or meta or para position with respect to the acetylene group.

7. An electric device as claimed in claim 2, wherein the layer of semiconductor material is selected from Si, SiC, Si₃N₄, or SiₓGe₁₋ₓ alloys or binary or multinary compounds or elements of groups III and V of the Periodic Table, selected from GaAs, InSb, InP, or AlₓGa1₋ₓAs.

8. An electric device as claimed in claim 6, wherein the layer of metallic material consists of gold, platinum, palladium or alloys of these metals with each other or with other metals.

9. An electric device as claimed in claim 1 for determining odorizing gases in combustible mixtures, wherein the layer of organic material is formed starting from at least one precursor molecule pertaining to the classes of general structure: 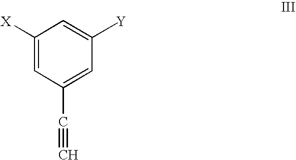
where X and Y are independently iodine or an SR group, in which R is chosen from the group comprising hydrogen and C₁-C₃ alkyl radicals.

10. An electric device as claimed in claim 1 for determining odorizing gases in combustible mixtures, wherein the layer of organic material is formed starting from at least one precursor molecule pertaining to the classes of general structure: 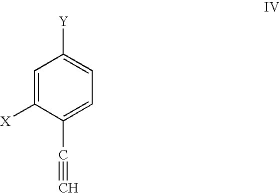
where X and Y are independently iodine or an SR group, in which R is chosen from the group comprising hydrogen and C₁-C₃ alkyl radicals.

11. An electric device as claimed in claim 1 for determining odorizing gases in combustible mixtures, wherein the layer of organic material is formed starting from at least one precursor molecule pertaining to the classes of general structure: 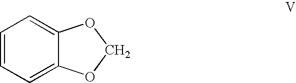
where X and Y are independently iodine or an SR group, in which R is chosen from the group comprising hydrogen and C₁-C₃ alkyl radicals.

12. An electric device as claimed in claim 1 for determining odorizing gases in combustible mixtures, wherein the semiconductor material consists of monocrystalline silicon.

13. An electric device as claimed in claim 1 for determining odorizing gases in combustible mixtures, wherein the semiconductor material consists of semiconductor alloys.

14. An electric device as claimed in claim 13 for determining odorizing gases in combustible mixtures, wherein the semiconductor material consists of alloys of SiₓGe₁₋ₓ type.

15. An electric device as claimed in claim 1 for determining odorizing gases in combustible mixtures, wherein the semiconductor material consists of binary or multinary compounds or elements of groups III and V of the Periodic Table.

16. An electric device as claimed in claim 15 for determining odorizing gases in combustible mixtures, wherein the semiconductor material is chosen from the group comprising GaAs, InSb, InP, or AlₓGa₁₋ₓAs.

17. An electric device as claimed in claim 1 for determining odorizing gases in combustible mixtures, wherein the metal material consists of a porous layer of gold, a porous layer of platinum, or a porous layer of palladium.

18. An electric device as claimed in claim 1 for determining odorizing gases in combustible mixtures, wherein the metallic material consists of a porous layer of a compound presenting metallic characteristics.

19. An electric device as claimed in claim 1 for determining odorizing gases in combustible mixtures, wherein the metallic material consists of a porous layer of an alloy containing at least one metal of the group comprising gold, platinum and palladium.

20. An electric device as claimed in claim 1 for determining odorizing gases in combustible mixtures, comprising a device coupled to a reducing gas sensor and controlled by an electronic logic comparator device.
